(19) United States
(12) Patent Application Publication
(10) Pub. No.: US 2026/0319126 A1
(43) Pub. Date: Oct. 15, 2026

(54) WORLD FRAME/LOCAL FRAME MAPPING AND RE-MAPPING IN A UTILITY LOCATING SYSTEM

(71) Applicant: SeeScan, Inc., San Diego, CA (US)

(72) Inventors: Mark S. Olsson, La Jolla, CA (US); Alexander L. Warren, Escondido, CA (US)

(21) Appl. No.: 19/558,465

(22) Filed: Mar. 6, 2026

Related U.S. Application Data
(60) Provisional application No. 63/770,287, filed on Mar. 11, 2025.

(51) Int. Cl. G01V 3/38; G01C 21/00; G01V 3/17

(52) U.S. Cl. CPC G01V 3/38; G01C 21/3811; G01C 21/3848; G01V 3/17

(57) ABSTRACT

This disclosure relates generally to systems and methods for locating and mapping buried or hidden utility objects. In one embodiment, a utility locator collects EM measurements in a local frame (from a locator perspective reference), then, internally, in real-time or near real-time at the locator, EM measurements are rotated into the world frame (transformed) so that they are aligned with gravity down (tilted), and rotated (yaw) into true north (not magnetic north). Once transformed, objects are represented in a global coordinate system relative to this fixed (true north) position. Other mapping and data layers may be combined with the transformed EM measurements, and displayed in the world frame. Combined and processed data can be rotated back into a gravity down position and yaw rotated into the local frame of a display to provide a “bird's-eye” view independent of locator tilt. The locator may be hand-held or vehicle mounted.

### CROSS-REFERENCE TO RELATED APPLICATIONS

This application claims priority under 35 U.S.C. § 119(e) to United States Provisional Patent Application Ser. No. 63/770,287, entitled WORLD FRAME/LOCAL FRAME MAPPING AND RE-MAPPING IN A UTILITY LOCATION SYSTEM, filed Mar. 11, 2025, the content of which is incorporated by reference herein in its entirety for all purposes.

### FIELD

This disclosure relates generally to systems and methods for locating and mapping buried or hidden utility objects. More specifically, but not exclusively, this disclosure relates to systems and methods for displaying buried utility objects on a map in a world frame reference view, or a local frame reference view, with the ability to toggle back and forth between perspectives.

### BACKGROUND

FIGS. 1A and 1B illustrate two alternative display perspectives or views, as known in the prior art. FIG. 1A illustrates a world frame view which uses a global or absolute reference frame that may be fixed, e.g. with north always pointing up on the top of the display screen. A world frame view represents objects in the global coordinate system showing objects relative to this fixed reference. On the other hand, FIG. 1B illustrates a local frame reference view, sometimes called an object view, which is specific to an object, for example, a camera. As the position or location of the camera changes, the display view changes, including the position of directional information on the display such as north, south, east, west, longitude, latitude, and other well know position and location related information. That is, a local frame reference view is relative to a device user's position and orientation. As an example, when the locator is rotated, the antenna(s) in the locator are also rotated, therefore, a utility that is displayed on the screen will also rotate. If for instance a utility line is in front of you, and you point the locator to the front, a line representing the utility will be displayed in front of you on the screen. If you turn the locator to the right, it will then correctly show the line to the left, and if you turn the locator to the left, it will show the line to the right of you on the display screen.

Although currently buried or hidden utility locators may work in either a world frame reference or a local frame reference view or mode, it is more common for a locator to work in a local frame context where the display may show a utility line's position relative to a user's orientation. This is crucial for accurate data representation. When switching between views, current methods may not provide completely accurate representations of maps, or mapped data related to hidden or buried utilities.

What is needed in the art is the ability to show a world frame view rotated into a local view perspective, including correcting for tilt to show a local view, and combining world frame elements with a local view perspective.

Accordingly, the present invention is directed towards addressing the above-described problems and other problems associated with switching between reference frame view.

### SUMMARY

This disclosure relates generally to systems and methods for locating and mapping buried utility objects. More specifically, but not exclusively, this disclosure relates to systems and methods for displaying buried utility objects on a map in a world frame reference view, or a local frame reference view, with the ability to toggle back and forth between perspectives.

When using a Utility Locator, sometimes referred to as a GLR (Geo-Locator-Receiver), to receive electromagnetic signals emitted from buried or hidden utilities, the detected utilities are often presented to a user on a display. Information may be presented or rendered on a dedicated display, i.e. on a display that is connected to the locator either hard wired or wirelessly. The display may be permanently attached to the locator, or may be removably detachable. In some embodiments, data collected from the locator may be transmitted wirelessly to a remote device such as a mobile phone, laptop, or tablet. The remote device may be handheld, and/or mounted in a vehicle. Data may be displayed on multiple devices, on multiple devices. Processing of data may occur locally on the utility locator, on a mobile device, or in the Cloud (using the utility locator or mobile device to transmit and/or receive data from the Cloud), or any combination of the aforementioned.

In one aspect, utility data is received or collected from a utility locator in the local frame, and then transformed into the world frame for accurate mapping. This involves knowing the locator's orientation to true north, and tilt taking into consideration gravity. As an example, when collecting utility data with a locator, an INS system (Inertial Navigation System) may be used to determine how the locator is rotated, and tilted with respect to gravity to true north (not magnetic north). Since you can determine how the locator is tilted with respect to gravity, you can determine the pose of the locator, that is the angle of tilt or rotation of the locator, along with its three-dimensional x, y, z coordinates in spherical angles. A spherical angle is used in three-dimensional space to describe the orientation and direction of the locator in terms of three angular measurements, typically involving a yaw, tilt, and roll.

In one aspect, a utility locator collects EM measurements in a local frame then, internally, in real-time or near real-time at the locator, EM measurements are rotated into the world frame so that they are aligned with gravity down (tilted, i.e. pitch and roll), and rotated (yaw) into true north (not magnetic north). Once rotated, objects are represented in a global coordinate system relative to this fixed (true north) position. Other mapping and data layers may be combined with the transformed EM measurements, and displayed in the world frame. If desired, combined and processed data may be rotated back into a gravity down position, but yaw rotated into the local frame of a display to provide a “bird's-eye” view independent of locator tilt (pitch and roll).

Transforming mapping data may include scaling, translating, and rotating data. There are numerous ways to transform mapping data which are well known in the art. Quaternions, a four-digit number, may be used to define the locator's pose (position, tilt, rotation, or orientation with respect to the ground or surface, or to another reference point in space), and to transform data from the local frame to the world frame. This is important for accurate spatial filtering and mapping. Filtering processes may be used keep or store data that aligns in the world frame, and discard data that does not align. This helps in identifying real utilities, and creating accurate maps. Once collected, and filtered, display transformation may include transforming data back to the local frame for display purposes, and ensuring that the map aligns with a user's perspective, e.g. to increase the usability of data for a user.

In one aspect, a locator is used to detect buried or hidden utility data. The utility data may be received in any direction based on the locators position and orientation, e.g. north, south, east, west, or any combination of these. Then, the utility data obtained in the local frame, transformed by rotating the data to fit into the world frame, and then stored or logged. This is done because maps are typically more useful in the world frame. Filtering of data would then be done in the world frame. Data may be saved locally, in a mobile device, in the Cloud, or any combination of these.

In one aspect, the problem of transforming data transformed into the world frame back to the local frame to be viewed while using a locator, is overcome by simply rotating the logged utility data. In either case, the idea is to rotate the data so that when a user looks down on a display, the utilities, typically represented as lines, line up with the map accurately, and present a view as if the user was holding the display vertically, and looking down at the display. This would provide a a bird's eye view, i.e. they view what they would see if they were looking down onto the mapped surface from above. Even if a user holds the display at non-vertical angle, e.g. 45 degrees, then looking down the view would be as if they were standing above themselves, looking straight down on the ground, and seeing all of the utilities.

In one aspect, a user may drive down a road in a vehicle equipped with one or more locators. The locator(s) may be removably attachable to the bumper, to a hitch, or located elsewhere on the vehicle. The locator may be used to follow a specific utility line which may require the driver to change lanes because the line changes position because it is routed around other underground utilities or obstacles. If the vehicle may be equipped with an onboard, integrated navigation system, such as GPS, GALILEO, GLONASS, etc., the user will be able to see the utility line displayed on the map.

A utility locator typically detects electromagnetic data, however, other sensors may provided to provide additional mapping data. For instance, environmental sensors, movement sensors, navigation sensors, and many other sensors known to one skilled in the art. Mapping data may also include imaging data, laser range finding system data, tagged asset data, utility survey and mapping data, and utility asset data. Data may be stored locally, on a remote device, at a data center, or in the Cloud.

In one aspect, a laser pointer spot pointing to the ground is measured first in the local frame. Assuming the ground is relatively flat, the laser point measures the distance from the locator to the point. Since you can know the position of the locator, you can determine the position/location of the laser point (also known as a dot, spot, or beam), on the ground. The determined ground position of the laser point may then be transformed into the world frame. As an example, if you had a tagged (annotated) laser beam point, and transformed the location to the world frame, and you had a camera, you could transform the laser point location data back to the local frame, and view the laser spot position the locator's display in the local frame in real-time or near real-time, as the location of the laser pointer is being calculated in terms of position and orientation in the local frame on a display.

In another aspect, a smartphone can be used as a relay to the Cloud. Some or all of the information from the locator can be streamed to the Cloud via the smartphone for AI processing, the processed data can then be relayed back to the locator using the smartphone. One advantage of Cloud processing is that any preexisting data, e.g. utility data from the same area, can be used in addition to the new data. As an example, similar map trends from the location of a utility survey being walked using a locator, a previous frequency sweep, etc., that provided some previous information related to a specific utility.

In some aspects, training data may be sent from a utility locator and/or a camera cable drum-reel along with a trained model that has been created on a Neural Network located on the utility locator and/or the camera cable drum-reel itself to a remote device for AI processing. In another aspect, only the training data may be sent to a remote device, a training model is created in a Neural Network on the remote device, and then the model can be used to process prediction data to obtain a prediction result. The remote device may also relay training data to the Cloud, a prediction model can be created in the Cloud, prediction data may then be relayed from the remote device to the Cloud to be used with the prediction model to obtain a prediction result. Prediction results from the Cloud can then be relayed back to the remote device. Any data from the Cloud or from the remote device may be displayed on the remote device and/or transmitted back to the locator and/or the camera cable drum-reel for display.

In one aspect, transforming from a world frame view to a local frame view comprises overlapping multiple view layers. As an example, a GLR (Geo-Locator-Receiver) layer local to a GLR device, and/or in memory, or currently being collected (could also include camera, and other sensor data), and a Cloud map layer may be combined or overlapped. Alignment of overlapping layers may include transformation steps such as scaling, translating, rotating, and aligning locator EM data to a third party map in the world frame with an unknown offset (e.g. Google Maps), and other mapping and image transformation techniques well known in the art. The local layer improves accuracy because it could be collected in real or near real-time. It should be noted that throughout this disclosure a locator refers to a GLR/locator, not the person using the GLR/locator.

In one aspect, a map layer may be filtered to only include items that would be seen from an overhead view, i.e. looking down from directly above. Filtering may be included to determine boundaries to ensure any offsets needed to align map layers are automatically determined. If a laser pointer is used, data from the laser pointer maybe incorporated into one or more of the map layers, i.e. so that the map is aligned with the location of the dot or point aimed at by the laser pointer. The laser pointer may include a range finding capability. Also, the laser pointer may include the ability to measure reflectance of the laser light back to the GLR/Locator.

In another aspect, overlapping layers to create a composite map may include a Cloud map layer, i.e. a layer mapping of known geographical, and/or utility line an asset features stored in the Cloud. As an example, GOOGLE MAPS, Overflight mapped views, and any other types of maps showing desired features. Another layer may include a local map, i.e. a map stored on a locator, and/or obtained in real or near real-time, and may also include other data such as INS data, environmental and other sensor data, and camera/imaging data. Another layer may include a data layer which is overlayed over the two previous mapping layers. The data layer may include utility line and location data that is stored, and/or obtained by a utility locator in real or near real-time.

In one aspect, utility and mapping data may be wirelessly streamed bidirectionally using WiFi or another streaming protocol between a utility locator, a vehicle, or a facility, either directly or relayed through a smartphone or other remote device. Some or all data could also be processed locally on the locator or in a vehicle, on the remote device, and/or in the Cloud.

In another aspect, the present disclosure includes a computer implemented method for displaying buried utility objects on a map in a world frame reference view, or a local frame reference view, with the ability to toggle back and forth between perspectives using Artificial Intelligence (AI). The method includes collecting locating data describing the positions and depths of utility lines in the ground from electromagnetic signals via one or more utility locator devices which may be hand-held or attached/mounted to a vehicle. Other data may also be collected and used, e.g. sensor data, laser pointer data which may include ranging data (e.g. LIDAR), reflectance, and/or reflectivity data, tagged/annotated utility asset data, environmental data, and any other types of data related to utility locating and surveying. The method further includes assembling a Training Database that includes Locating Data, and may also include Predetermined Classifier Data. Next, Deep Learning used to train a Neural Network (Artificial Intelligence/AI) via the Training Database Data. AI is then used to generate predictions regarding the positions of utility lines and utility line characteristics. The outputted predictions are then stored, and/or mapped from a local frame, and transformed to the world frame, again using AI to predict the best fit for mapping the data in the new perspective. Also, AI is best suited for analyzing the patterns of large data sets, and predictions related to the data, e.g. what type of utility, connections, terminations, locations, routes, ownership (i.e. utility or cable company, etc.), depth, technical specifications/characteristics, and the like. An example of using AI to analyze large sets of utility data, and make predictions related to utility locations and characteristics is U.S. patent application Ser. No. 17/935,564, filed Sep. 26, 2022, entitled SYSTEMS AND METHODS FOR DETERMINING AND DISTINGUISHING BURIED OBJECTS USING ARTIFICIAL INTELLIGENCE, the content of which is hereby incorporated by reference herein in its entirety for all purposes.

As an example, collected utility data is used to formulate a model using Deep Learning. New data is then input into the model, and AI is used to make a prediction of the type and location of utility assets, and map, i.e. insert or overlay those utility assets on a geographical map in the world frame. The mapped utility assets may then be transformed to the local frame, and displayed in real or near real-time. As a user is moving along using a locator, the identified utility lines are then inserted or overlayed on the transformed map in real or near real-time allowing a user to see what the locator is seeing as it moves along the locate or survey path.

As an example, a user locates an electrical utility line using a utility locator while walking adjacent to a side walk towards a traffic intersection. Mapping data, including geographical data, and utility asset data, stored locally or remotely is provided to the locator, and transformed to the local frame at the locator, or the data in the world frame may transformed to the local frame remotely in the cloud, and/or on a mobile device, and then provided to the locator. As the user is walking along, the display either on the locate device itself or on a remote display, will show the electrical utility line running along the sidewalk, and approaching the intersection. GNS and other satellite location systems provide exact location data for the locator, and various sensors provide information to the position and orientation of the locator. Other previously known features, e.g. utility meters, boxes above ground, other utility lines hidden or buried, and other relevant features may be displayed as well. Other relevant information may also be displayed, e.g. directional and position information, depth of utility information, and any other utility and environmental features that are well known in the art. Any location data, calculation data, or mapping data may be stored locally and/or remotely, and may also be transmitted back to the Cloud, and/or another location for further processing, or storage, and may also be used as training data to build or enhance a new or existing AI model.

In one aspect, the depth of mapped utilities are color coded on the display, with utilities of different depths having different colors. Different colors may also be used to distinguish other buried or hidden utility asset characteristics, or features. For instance, in one embodiment gas lines may be color coded yellow, water pipes blue, electrical lines red, etc. It would be obvious to one skilled in the art that any color or combination of colors can be used, as desired, to represent different utility asset, or geographical mapping characteristics. In one embodiment, a user may toggle between colors, as needed.

In another embodiment, a user may place a flag or other marker over a desired object or location, to obtain more information about the flagged or marked object. For instance, a user may want to know what the quality metric or confidence level is that a specific mapped object is what the display actually shows, e.g. the type of utility line, location, orientation, depth, connections, pipe shape and size, etc. This would be especially useful to an excavator, construction worker, planning or engineering personnel, etc. For instance, someone wanting to ensure that it is safe to dig based on the distance or depth from a gas line, or an engineer needing to know if it is a single phase or three phase transformer, and other electrical characteristics.

In another aspect, the display may be mounted so that it is rotatable (can change direction), tiltable (can change angle), or otherwise positionable. Changing the position of the display may be employed to provide VR (Virtual Reality), and/or AR (Augmented Reality) perspectives. When the rotation and/or angle changes, the display may be configured to make any directional, and mapping changes/adjustments needed to keep the mapped utilities accurate. The display may also be configured to change from a local frame view to a world frame view, and vice versa. As an example, the current view perspective, e.g. a local frame view would change to an alternate view, e.g. a world frame view if the display is rotated approximately 90 degrees on a mount, or while handheld.

Various additional aspects, features, and functions are describe below in conjunction with the Drawings.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,443,154, issued Oct. 28, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,336,078, issued Feb. 26, 2008, entitled MULTI-SENSOR MAPPING OMNIDIRECTIONAL SONDE AND LINE LOCATORS; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued Jan. 4, 2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUDLY INDICATING THE DIFFERENT LOCATIONS TO A USER; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,081,109, issued Jul. 14, 2015, entitled GROUND-TRACKING DEVICES FOR USE WITH A MAPPING LOCATOR; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,465,129, issued Oct. 11, 2016, entitled IMAGE-BASED MAPPING LOCATING SYSTEM; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,523,788, issued Dec. 20, 2016, entitled MAGNETIC SENSING BURIED OBJECT LOCATOR INCLUDING A CAMERA; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); U.S. patent application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; U.S. patent application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,784,837, issued Oct. 10, 2017, entitled OPTICAL GROUND TRACKING APPARATUS, SYSTEMS & METHODS; U.S. patent application Ser. No. 15/811,361, filed Nov. 13, 2017, entitled OPTICAL GROUND-TRACKING APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar., 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 208, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. patent application Ser. No. 16/036,713, issued Jul. 16, 2018, entitled UTILITY LOCATOR APPARATUS AND SYSTEMS; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U. S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/810,788, filed Mar. 5, 2019, entitled MAGNETICALLY RETAINED DEVICE HANDLES; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. patent application Provisional Patent Application 63/015,692, filed Apr. 27, 2020, entitled SPATIALLY AND PROCESSING-BASED DIVERSE REDUNDANCY FOR RTK POSITIONING; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. patent application Provisional Patent Application 63/055,278, filed Jul. 22, 2020, entitled VEHICLE-BASED UTILITY LOCATING USING PRINCIPAL COMPONENTS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTLITITY LOCATOR INCLUDING A CAMERA; U.S. patent application Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. patent application Ser. No. 17/013,831, filed Sep. 7, 2020, entitled MULTIFUNCTION BURIED UTILITY LOCATING CLIPS; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Provisional Patent Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; and U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDOE INPECTION SYSTEMS WITH PERSONAL COMMUNICATION DEVICE USER INTERFACES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,956, filed Nov. 17, 2021, entitled VIDEO INSPECTION SYSTEM, APPARATUS, AND METHODS WITH RELAY MODULES AND CONNECTION PORT; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM, APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Provisional Patent Application 63/293,828, filed Dec. 26, 2021, entitled MODULAR BATTERY SYSTEMS INCLUDING INTERCHANGEABLE BATTERY INTERFACE APPARATUS; U.S. Pat. No. 11,209,115, issued Dec. 28, 2021, entitled PIPE INSPECTION AND/OR MAPPING CAMERA HEADS, SYSTEMS, AND METHODS; U.S. patent application Ser. No. 17/563,049, filed Dec. 28, 2021, entitled SONDE DEVICES WITH A SECTIONAL FERRITE CORE; U.S. Provisional Patent Application 63/306,088, filed Feb. 2, 2022, entitled UTILITY LOCATING SYSTEMS AND METHODS WITH FILTER TUNING FOR POWER GRID FLUCTUATIONS; U.S. patent application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILTY LOCATING SYSTEMS AND METHODS WITH FILTER TUNING FOR POWER GRID FLUCTUATIONS; U.S. patent application Provisional Patent Application 63/485,905, filed Feb. 18, 2023, entitled SYSTEMS AND METHODS FOR INSPECTION ANIMATION; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,613, issued Mar. 28, 2023, entitled DOCKABLE CAMERA CABLE DRUM-REEL AND CCU SYSTEM; U.S. Pat. No. 11,649,917, issued May 16, 2023, entitled INTEGRATED FLEX-SHAFT CAMERA SYSTEM WITH HAND CONTROL; U.S. Pat. No. 11,665,321, issued May 30, 2023, entitled PIPE INSPECTION SYSTEM WITH REPLACEABLE CABLE STORAGE DRUM; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,686,878, issued Jun. 27, 2023, entitled ELECTRONIC MARKER DEVICES FOR BURIED OR HIDDEN USE; U.S. Provisional Patent Application 63/524,698, filed Jul. 2, 2023, entitled FILTERING METHODS AND ASSOCIATED UTILITY LOCATOR DEVICES FOR LOCATING AND MAPPING BURIED UTILITY LINES; U.S. Provisional Patent Application 63/514,090, filed Jul. 17, 2023, entitled SMARTPHONE MAPPING APPARATUS FOR ASET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,646, issued Aug. 8, 2023, entitled PIPE MAPPING SYSTEMS AND METHODS; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; U.S. Provisional Patent Application Ser. No. 18/490,763, filed Oct. 20, 2023, entitled LINKED CABLE-HANDLING AND CABLE-STORAGE DRUM DEVICES AND SYSTEMS FOR COORDINATED MOVEMENT OF PUSH-CABLE; U.S. Pat. No. 11,796,707, issued Oct. 24, 2023, entitled USER INTERFACES FOR UTILITY LOCATORS; U.S. patent application Ser. No. 18/544,042, filed Dec. 18, 2023, entitled SYSTEMS, APPARATUS, AND METHODS FOR DOCUMENTING UTILITY POTHOLES AND ASSOCIATED UTILITY LINES; U.S. Pat. No. 11,876,283, issued Jan. 16, 2024, entitled COMBINED SATELLITE NAVIGATION AND RADIO TRANSCEIVER ANTENNA DEVICES; U.S. Pat. No. 11,894,707, issued Feb. 6, 2024, entitled RECHARGEABLE BATTERY PACK ONBOARD CHARGE STATE INDICATION METHODS AND APPARATUS; U.S. Pat. No. 11,909,104, issued Feb. 20, 2024, entitled ANTENNAS, MULTI-ANTENNA APPARATUS, AND ANTENNA HOUSINGS; U.S. Provisional Patent Application 63/558,098, filed Feb. 26, 2024, entitled SYSTEMS, DEVICES, AND METHODS FOR DOCUMENTING GROUND ASSETS AND ASSOCIATED UTILITY LINES; U.S. Pat. No. 11,921,225, issued Mar. 5, 2024, entitled ANTENNA SYSTEMS FOR CIRCULARLY POLARIZED RADIO SIGNALS; U.S. patent application Ser. No. 18/611,449, filed Mar. 20, 2024, entitled VIDEO INSPECTION AND CAMERA HEAD TRACKING SYSTEMS AND METHODS; U.S. Pat. No. 11,953,643, issued Apr. 9, 2024, entitled MAP GENERATION BASED ON UTILITY LINE POSITION AND ORIENTATION ESTIMATES, U.S. Pat. No. 11,962,943, issued Apr. 16, 2024, entitled INSPECTION CAMERA DEVICES AND METHODS; U.S. Provisional Patent 63/643,915, filed May 7, 2024, entitled SYSTEMS AND METHODS FOR LOCATING AND MAPPING BURIED UTILITY OBJECTS USING ARTIFICIAL INTELLIGENCE WITH LOCAL OR REMOTE PROCESSING; U.S. Pat. No. 11,988,951, issued May 21, 2024, entitled MULTI-DIELECTRIC COAXIAL PUSH-CA-BLES AND ASSOCIATED APPARATUS; U.S. Provisional Patent 63/659,722, filed Jun. 13, 2024, entitled VEHICLE-MOUNTING DEVICES AND METHODS FOR USE IN VEHICLE-BASED LOCATING SYSTEMS; U.S. Provisional Application Ser. No. 18/747,912, filed Jun. 19, 2024, entitled INNER DRUM MODULE WITH PUSH-CABLE INTERFACE FOR PIPE INSPECTION; and U.S. Provisional Application Ser. No. 18/758,937, filed Jun. 28, 2024, entitled FILTERING METHODS AND ASSOCIATED UTILITY LOCATOR DEVICES FOR LOCATING AND MAPPING BURIED UTILITY LINES; U.S. patent application Ser. No. 18/774,758, filed Jul. 16, 2024, entitled SMARTPHONE MOUNTING APPARATUS AND IMAGING METHODS FOR ASSET TAGGING AND UTILITY MAPPING AS USED WITH UTILITY LOCATING DEVICES; U.S. Provisional Patent 63/674,749, issued Jul. 23, 2024, entitled PIPE MAPPING FOR FEATURE AND ASSET RECOGNITION USING ARTIFICIAL INTELLIGENCE; U.S. Provisional Patent 63/692,642, issued Sep. 9, 2024, entitled ELECTRONIC MODULES AND ASSOCIATED SYSTEMS; U.S. Provisional Patent 63/694,102, issued Sep. 12, 2024, entitled METHODS AND APPARATUS FOR BATTERY SWAPPING IN UTILITY LOCATOR DEVICES AND OTHER COMPLEX BOOTABLE ELECTRONIC DEVICES; U.S. Provisional Patent 63/719,026, issued Nov. 11, 2024, entitled PUSH-CABLE WITH OFFSET JACKET EXTRUSION; U.S. Provisional Patent 63/726,858, issued Dec. 2, 2024, entitled DIGITAL SELF-LEVELING PIPE INSPECTION CAMERA SYSTEMS AND METHODS WITH AUTOMIC MAGNIFICATION; and U.S. patent application Ser. No. 19/018,842, issued Jan. 13, 2025, entitled ACCESSIBLE DRUM-REEL FRAME FOR PIPE INSPECTION CAMERA SYSTEM; U.S. Provisional Patent Application 63/761,029, filed Feb. 20, 2025, entitled UTILITY LOCATING SYSTEMS, DEVICES, AND METHODS EMPLOYING SPATIAL AUDIO; U.S. patent application Ser. No. 19/059,288, filed Feb. 21, 2025, entitled SYSTEMS, DEVICES, AND METHODS FOR DOCUMENTING GROUND ASSETS AND ASSOCIATED UTILITY LINES; U.S. Provisional Patent Application 63/770,287, filed Mar. 11, 2025, entitled WORLD FRAME/LOCAL FRAME MAPPING AND RE-MAPPING IN A UTILITY LOCATION SYSTEM; U.S. Pat. No. 12,253,382, issued Mar. 18, 2025, entitled VEHICLE-BASED UTILITY LOCATING USING PRINCIPAL COMPONENTS; U.S. patent application Ser. No. 18/198,495, filed May 18, 2025, entitled SYSTEMS AND METHODS FOR LOCATING AND MAPPING BURIED UTILITY OBJECTS USING ARTIFICIAL INTELLIGENCE WITH LOCAL OR REMOTE PROCESSING; U.S. patent application Ser. No. 19/234,473, filed Jun. 11, 2025, entitled VEHICLE-MOUNTING DEVICES AND METHODS FOR USE IN VEHICLE-BASED LOCATING SYSTEMS; U.S. Pat. No. 12,360,251, issued Jul. 15, 2025, entitled GNSS POSITIONING METHODS AND DEVICES USING PPP-RTK, RTK, SSR, ORLIKE CORRECTION DATA; U.S. Pat. No. 12,360,282, issued Jul. 15, 2025, entitled NATURAL VOICE UTILITY ASSET ANNOTATION SYSTEM; U.S. Pat. No. 12,363,251, issued Jul. 15, 2025, entitled SYSTEMS AND METHODS FOR INSPECTION ANIMATION; U.S. patent application Ser. No. 19/274,389, filed Jul. 18, 2025, PIPE MAPPING FOR FEATURE AND ASSET RECOGNITION USING ARTIFICIAL INTELLIGENCE; U.S. Pat. No. 12,368,944, issued Jul. 22, 2025, entitled INNER DRUM MODULE WITH PUSH-CABLE INTERFACE FOR PIPE INSPECTION; U.S. Pat. No. 12,374,875, issued Jul. 29, 2025, entitled INSPECTION SYSTEM PUSH-CABLE GUIDE APPARATUS; U.S. Pat. No. 12,374,876, issued Jul. 29, 2025, entitled VEHICLE INSPECTION SYSTEM APPARATUS AND METHODS WITH RELAY MODULES AND CONNECTION PORTS; U.S. patent application Ser. No. 19/324,044, filed Sep. 9, 2025, entitled ELECTRONIC MODULES AND ASSOCIATED SYSTEMS; U.S. patent application Ser. No. 19/324,880, filed Sep. 10, 2025, entitled METHODS AND APPARATUS FOR BATTERY SWAPPING IN UTILITY LOCATOR DEVICES AND OTHER COMPLEX BOOTTABLE ELECTRONIC DEVICES; U.S. patent application Ser. No. 19/382,881, filed Nov. 7, 2025, entitled PUSH-CABLE WITH OFFSET JACKET EXTRUSION; U.S. patent application Ser. No. 19/403,144, filed Nov. 27, 2025, entitled DIGITAL SELF-LEVELING PIPE INSPECTION CAMERA SYSTEMS ANDMETHODS WITH AUTOMATIC MAGNIFICATION; U.S. Provisional Patent Application 63/918,986, filed Nov. 17, 2025, entitled METHODS AND SYSTEM FOR VIDEO DENOISING USING ARTIFICIAL INTELLIGENCE; U.S. Provisional Patent Application 63/926,630, filed Nov. 27, 2025, entitled WEBSERVER INTERFACE IN UTILITY LOCATING AND PIPE INSPECTION SYSTEMS; U.S. Pat. No. 12,489,871, issued Dec. 2, 2025, entitled VIDEO PIPE INSPECTION AND CAMERA HEAD TRACKING SYSTEMS AND METHODS; U.S. Pat. No. 12,510,376, issued Dec. 30, 2025, entitled SYSTEMS, APPARATUS, AND METHODS FOR DOCUMENTING UTILITY POTHOLES AND ASSOCIATED UTILITY LINES; U.S. Pat. No. 12,529,442, issued Jan. 1, 2026, entitled INWARD SLOPED DRUM FACE FOR PIPE INSPECTION CAMERA SYSTEM; and U.S. Provisional Patent Application 63/982,379, filed Feb. 13, 2026 entitled SEALED BEARING. The content of each of the above-described patents and applications is incorporated by reference herein in its entirety. The above applications may be collectively denoted herein as the “co-assigned applications” or “incorporated applications.”

### BRIEF DESCRIPTION OF THE DRAWINGS

FIG. 1A illustrates an embodiment of a display screen with a world frame view, as known in the prior art.

FIG. 1B illustrates an embodiment of a display screen with a local frame view, as known in the prior art.

FIG. 2 is an illustration of an embodiment of a utility data collection system for collecting underground or buried utility location data with a handheld utility locator/GLR (Geo-Locator-Receiver), as well as for tagging above ground utility assets or objects, in accordance with certain aspects of the present invention.

FIG. 3 is an illustration of an embodiment of a vehicle based locating device for collecting underground or buried utility location data, in accordance with certain aspects of the present invention.

FIG. 4 is an illustration of an embodiment of a system for tagging identified utility assets or objects related to underground utilities, in accordance with certain aspects of the present invention.

FIG. 5 is an illustration of an embodiment of a method transforming utility locator data from a local frame to a world frame, and back to a local frame in a utility locating system, in accordance with certain aspects of the present invention.

FIG. 6 is an illustration of an embodiment of a system for aligning multiple mapping layers to create a composite map in the local frame, in accordance with certain aspects of the present invention.

FIG. 7 is an illustration of an embodiment of a method for transforming utility locator data from a local frame to a world frame, and back to a local frame in a utility locating system, the method using Artificial Intelligence (AI), in accordance with certain aspects of the present invention.

FIG. 8 is an illustration of an embodiment of a method for creating a composite map of utility location data to be rendered in a local frame reference, in accordance with certain aspects of the present invention.

### DETAILED DESCRIPTION OF EMBODIMENTS

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

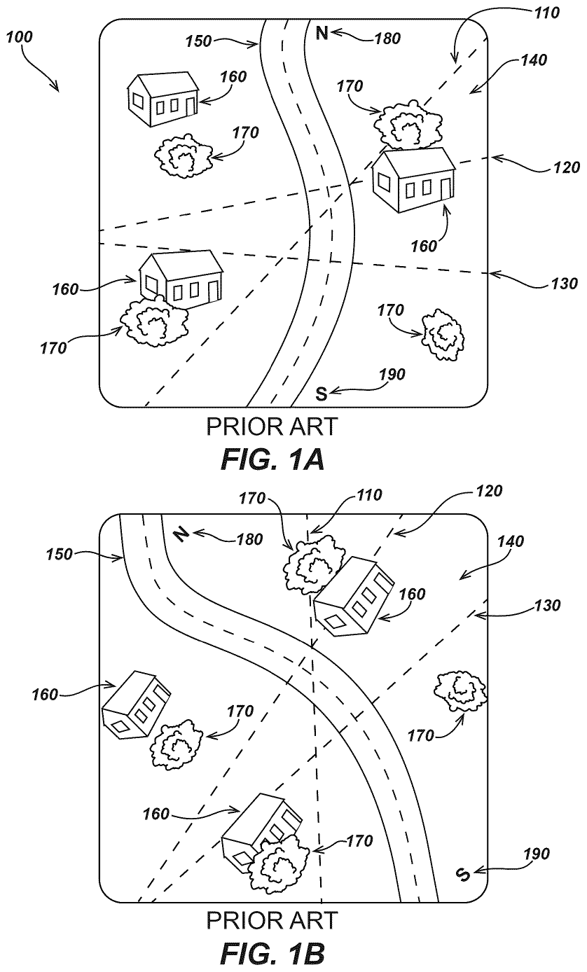

FIGS. 1A and 1B illustrate details of an exemplary embodiment of a display screen 100 with a world frame view, and a local frame view, respectively, as known in the prior art. Buried utility lines 110, 120, and 130 are represented by dashed lines, and are shown on a geographical map 140 in relation to a highway or road 150. Various environmental objects or features, e.g. house or other building structure 160, plants, shrubs, natural or unnatural features etc. are shown 170. North (N) 180 and South 190 (S) directions are also shown.

Since FIG. 1A illustrates a world frame view of reference, North (N) will always be shown towards the top of the display, regardless of the orientation of the user/viewer. On the other hand, FIG. 1B illustrates a local frame view, so as the user changes the orientation or position of a hand-held GLR/locator (not shown), the display 100 will rotate with respect to the “view of the locator”, i.e. the direction the locator is pointing. In the example of FIG. 1B, the direction of the locator is turning or veering towards the left, so FIG. 1A shows that the geographical map 140, all of the environmental objects or features, 160 and 170, as well as utility lines 110, 120, and 130 all being rotated with respect to the changing position of the GLR/Locator. It would be understood by one of ordinary skill in the art that the locator could be moved left, right, forward, or backwards, or in any combination of these directions, and the view on display 100 would adjust accordingly with respect to the point of view of the GLR/locator. It would also be understood by one skilled in the art that display 100 could include many other geographical objects and features, coordinates such as latitude, and longitude, or other navigation coordinates, GLR status information such as battery/power level, utility type, depth, technical specifications, ownership, or other information that may be needed by a surveyor or other user of the GLR/locator.

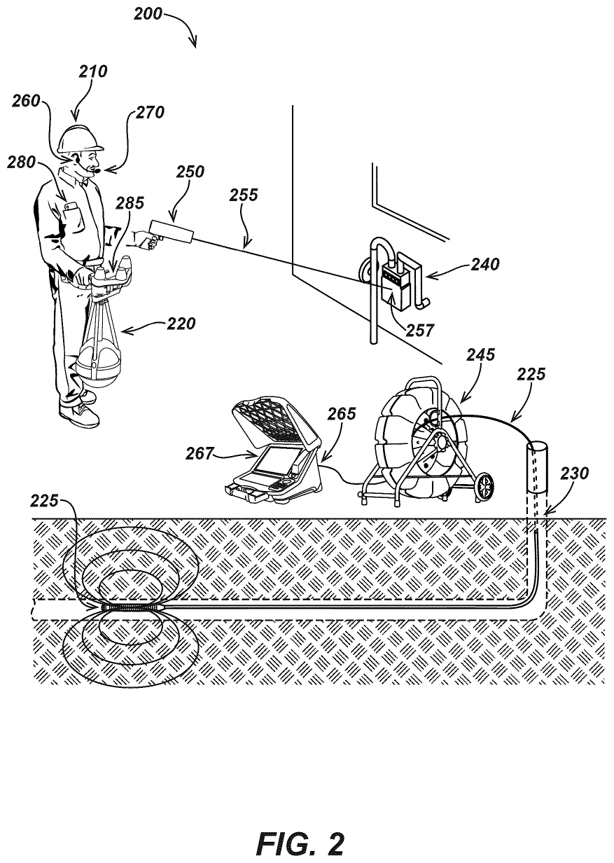

FIG. 2 is an illustration of an embodiment of a utility data collection system 200 for collecting underground or buried utility location data with a handheld utility locator/GLR (Geo-Locator-Receiver), as well as for tagging above ground utility assets or objects. A utility service worker or other user 210 is shown collecting data with a utility locator/GLR (Geo-Locator-Receiver) 220 that is related to an underground utility, e.g. an electrical, gas, or water line 230. The underground utility 230 is shown connected to a utility asset or object 240. The user 210 is shown holding a laser pointer, range finder, or reflectometer 250. Optionally, a laser pointer, range finder, or reflectometer 250 may be mounted on the GLR 220. The user 210 may tag utility asset 240 by aiming laser beam 255 at the utility asset 240 by placing laser point or dot 257 on utility asset or object 240, using a trigger or other laser pointer activation control (not shown), speaking into a headset 260 which includes a microphone 270, e.g. a boom microphone, and naming (annotating) the utility asset or object 240. In some embodiments, headset 260 would be optional as a mobile device 280 such as a cellular phone, mobile phone, or other wireless device could be used to provide a microphone and/or speaker. GLR 220 may include a display 285, and the mobile device 280 may include a display as well (not shown), e.g. the display on a cellular phone. A voice recognition application running locally on a mobile device 280, and/or connected to the cloud, and/or on GLR 220, and/or other computing device will interpret the speech used to name utility asset or object 240, and repeat it back to user 210 via an audio output device in headset 260. The user 210 may then accept or reject the tagged object by speaking an audio command into boom microphone 270. The position of the tagged laser spot may be determined using the GLR position and orientation, and the range measured from the laser point to the laser pointer, range finder, or reflectometer 250. One or more processors (not shown) may be integral with one or more of headset 260, laser pointer, range finder, or reflectometer 250, mobile device 280, or GLR 220.

If a mobile device 280 is used instead of a headset 260, the mobile device 280 should be oriented in a position to optimize the use of the microphone incorporated in or with the mobile device 280.

System 200 may also include a camera 225 attached to the distal end of a push-cable 235 which may be stored in, or deployed from a cable drum-reel 245 into a pipe or conduit 230. A CCU (camera control unit) 265 may be provided to control the camera 225. CCU 225 may include a display 267. Camera control unit 265, as well as locator 220, may include one or more wireless communication modules (not shown) to communicate with each other, or communicate with another wireless device, e.g. mobile device 280.

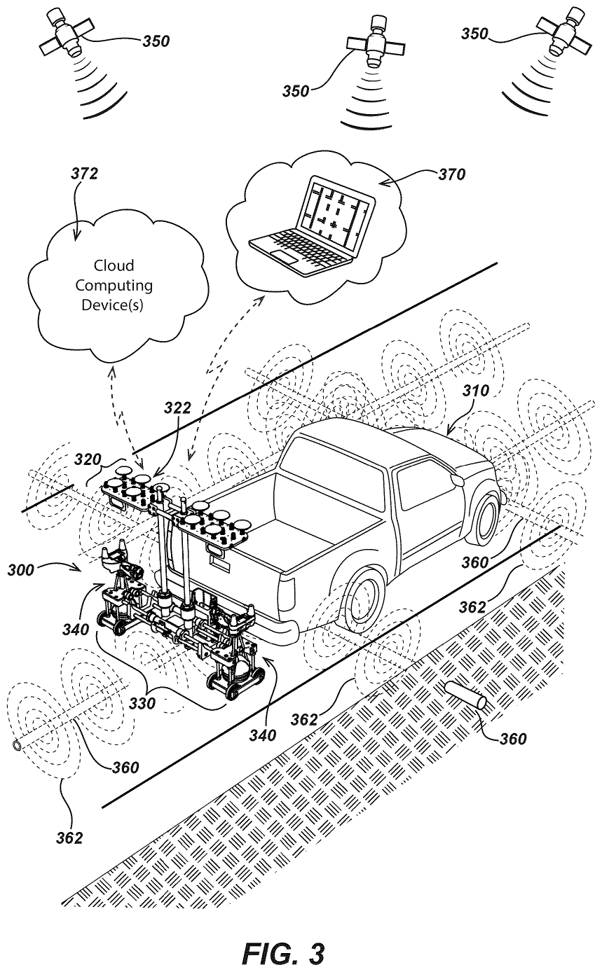

FIG. 3 illustrates details of an exemplary vehicle-based utility locating device 300 based locating system for collecting underground or buried utility location data. Vehicle-based utility locating device 300 may be secured to a vehicle 310. The vehicle-based utility locating device 300 may include a position element 320 including one or more GNSS antennas and associated receivers, such as the GNSS antennas/receivers 322 which may communicate with one or more navigation satellites 350, to determine position data of the vehicle-based utility locating device in the world frame. Likewise, the position element may include one or more other sensors or systems to determine position position element 320 may further include one or more inertial navigation system (INS) sensors (not shown) which may include gyroscopic sensors, accelerometers, magnetometers, or the like and/or other position sensors for determining movement or position in the world frame (e.g., light detection and radar (LiDAR) systems, other rangefinders, optical or mechanical ground tracking devices, or the like as well as systems, sensors, and methods associated with simultaneous localization and mapping (SLAM) or similar techniques). Different position sensors and systems may be included in other vehicle-based utility locating device embodiments in keeping with the present disclosure.

The vehicle-based utility locating device 300 may further include a utility locating element 330 for sensing electromagnetic signals that may be emitted by one or more utility lines that may be buried in the ground and use the sensed electromagnetic signals to determine the presence and location or absence of buried utility lines. In the vehicle-based utility locating device 300, the utility locating element 330 may be or include one or more human-portable utility locator devices 340 such as those described in the incorporated patent applications including, but not limited to, U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,078,149, issued Sep. 18, 2018, entitled BURIED OBJECT LOCATOR APPARATUS AND SYSTEMS; and U.S. Pat. No. 10,162,074, issued Dec. 25, 2018, entitled UTILITY LOCATORS WITH RETRACTABLE SUPPORT STRUCTURES AND APPLICATIONS THEREOF.

Each human-portable utility locator device 340 may include one or more antenna nodes (not shown) to sense magnetic fields 362 emitted from one or more buried utility lines such as utility line 360 as the vehicle-based utility locating device 300 is moved through an area of interest. In some embodiments, the antenna nodes may house a dodecahedral array of antennas. One or more wired or wireless computing devices 370 may be included for processing data in real-time, near real-time, or for post-processing, and/or communicating utility or other data to one or more cloud computing devices 372.

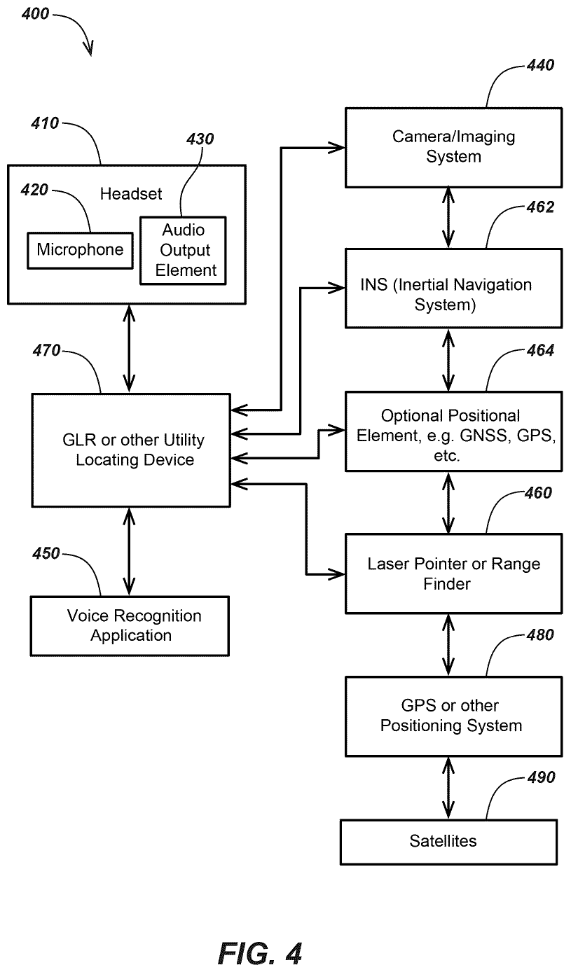

FIG. 4 illustrates components in an embodiment 400 in a system for tagging utility assets or objects. A headset 410 with an integrated microphone 420 and an audio output element 420 and an audio output element 430, may be provided. The headset is configured to communicate with a GLR or other utility locating device 470. GLR or other utility locating device 470 is configured to communicate with a voice recognition application 450 which may be integral with the GLR or other utility locating device 470, or may be remotely located elsewhere. A laser pointer or range finder 460 may be configured to communicate with the GLR or other utility locating device 470. Laser pointer or range finder 460 may be configured to communicate with GPS or other positioning systems 480, which may be configured to communicate with appropriate positioning satellites 490. It would be understood by those of ordinary skill in the art that communications between components can hardwired or configured to communicate wirelessly using well known protocols such as Bluetooth, WiFi, NFC, etc., either directly, or relayed through a mobile device such as a mobile phone, laptop, tablet, or vehicle navigation system. A camera or imaging system 440, an INS (Inertial Navigation System) 462, and/or optional positional elements, e.g. GNSS, GPS, etc., may be provided, and configured to communicate with GLR 470.

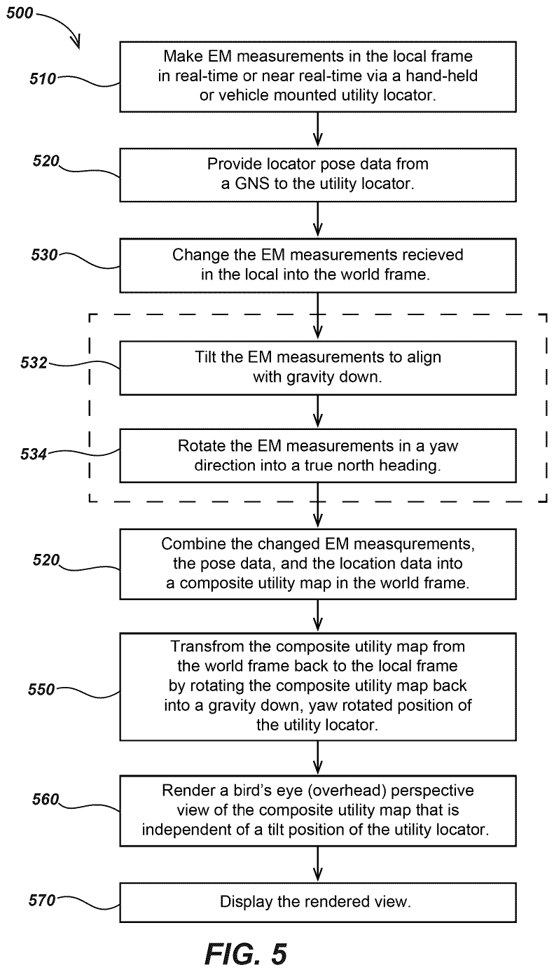

FIG. 5 illustrates details of an exemplary method transforming utility locator data from a local frame to a world frame, and back to a local frame in a utility locating system, in accordance with certain aspects of the present invention. The method 500 starts at step 510 making EM measurements in the local frame in real-time or near real-time via a hand-held or vehicle mounted utility locator. In step 520, locator pose data is provided from a Global Navigation system to the utility locator. Pose data may include how the locator is tilted with respect to gravity, e.g. the angle of tilt or rotation of the locator, along with its three-dimensional x, y, z coordinates in spherical angles. A spherical angle is used in three-dimensional space to describe the orientation and direction of the locator in terms of two angular measurements, typically involving an azimuth and elevation (sometimes referred to in terms of pitch, yaw, and roll).

The method 500 then proceeds to step 530 where the EM measurements in the local frame are changed or transformed into the world frame. Step 530 includes substeps 532 and 534. In substep 532, the EM measurements are aligned with gravity down, i.e. the data representing the EM measurements is oriented down so that it matches the vertical direction on a map in the direction of gravity. Gravity down also refers to the way a viewed map is experienced in reality. In substep 534, the EM measurements are rotated in a yaw direction into a true north heading. In some embodiments, substeps 532 and 534 may be done in any order, i.e. substep 534 first, and then substep 532, or in parallel, at the same time, or substantially the same time.

Method 500 then proceeds to step 540 where the changed or transformed EM measurements, the pose data, and the location data are combined into a composite utility map in the world frame. In step 550, the composite map is transformed from the world frame back to the local frame by rotating the composite utility map back into a gravity down, yaw rotated position in the local frame.

In step 560, a bird's eye (overhead) perspective view of the composite utility map is rendered that is independent of the tilt position of the utility locator. In step 570, the rendered view from step 560 is displayed. Since the the view that is displayed in a local view allows a user to, in a sense, see what the utility locator is seeing as the locator is moved because the display perspective is in a local view. The composite utility map may be displayed at the locator, or on a remote device such as a mobile phone, laptop, tablet, or vehicle navigation system.

The utility locator may include a user interface with options such as choosing viewing or mapping filter criteria. For instance, the filter criteria may be a certain location, a specific time frame, a certain time of map (e.g. including or excluding certain features or terrain), or may include or exclude any other type of mapping feature obvious to one of ordinary skill in the art.

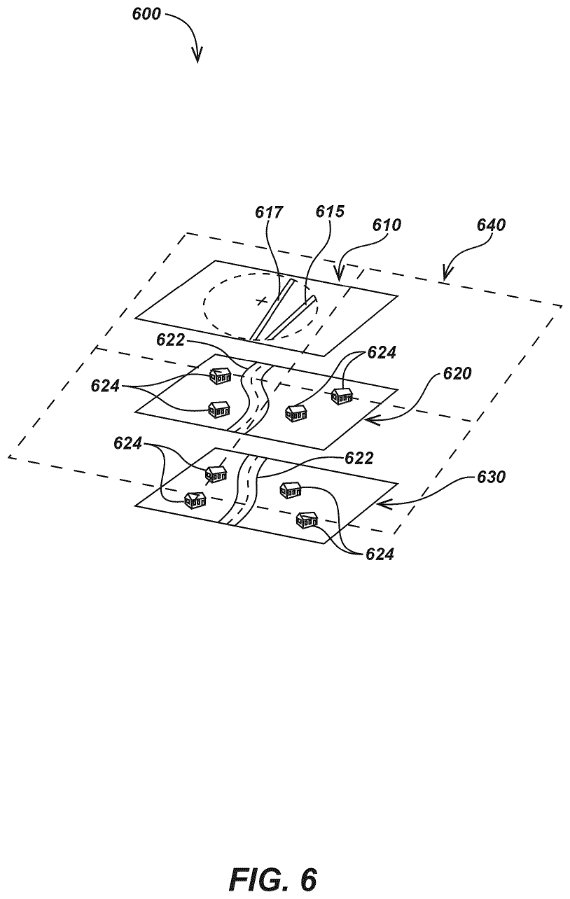

FIG. 6 illustrates details of an exemplary embodiment of a system 600 for aligning multiple mapping layers to create a composite map in the local frame. Multiple mapping layers may be used to create a composite map in the local frame.

For instance, a utility data layer 610 may include electromagnetic (EM) measurement data obtained from a a utility locator/GLR real or near real-time in a local frame, which has been converted to the world frame (see FIG. 5). Utility layer 610 may also include other data obtained such as sensor data, INS data, GPS data, environmental and other sensor data, and camera/imaging data. Other data may be stored or received locally in the GLR, or obtained remotely (wired or wireless) from other sources such as a utility imaging system, wireless communication devices, the Cloud, or other remote servers. Other data may include data obtained in the world frame, or data received in the local frame, and converted to the world frame so that utilty layer 610 is composed entirely of data in the world frame.

A first mapping layer 620 stored or obtained from a GLR, or a mobile device in communication with a GLR, camera or other imaging system, INS system, etc., and a second mapping layer 630 which may be obtained from a remote location such as the Cloud, i.e. a cloud server, Google, over-flight obtained data (e.g. overhead data obtained from an aircraft), or other remote database. Other mapping or data layers may be included. Each mapping layer may be positioned and overlayed relative to each other mapping layer using an alignment in the world frame with reference grid 640. Alignment grid 640 may be expanded and/or reduced in size depending on the desired final composite map size desired, or resolution of the display. Each individual layer may be positioned by filtering, scaling, translating, or rotating the layer to align with one or more other layers based on alignment grid 640. For instance, utility data layer 610, first mapping layer 610, and second mapping layer 630 may be aligned in the world frame relative to geographical coordinates which represent a desired location or region. Once correctly positioned, i.e. aligned, utility data layer 610, first mapping layer 610, and second mapping layer 630 may be overlayed or otherwise merged, to create a composite map showing utility data such as for example, utility lines 615 and 617, and other landmark features, e.g. road 622, housing or building structures 624 relative to the surround local geographical environment from the first mapping layer 620 and the second mapping layer 630. Other features may be shown, and are well known in the art. For instance, road signs or other markers, utility features or assets such as utility boxes, manhole covers, signage, geographical features such as hills, mountains, valleys, land contours, etc.

Once a composite map including utility data layer 610, first mapping layer 610, and second mapping layer 630, and any other optional layers (not shown) is aligned in the world frame, it will be converted back to the local frame (see FIG. 5) to be rendered from bird's eye (overhead) perspective view of the composite utility map that is independent of a tilt position of the utility locator. The composite map rendered in the local frame may then be displayed at the utility locator/GLR, and/or remotely.

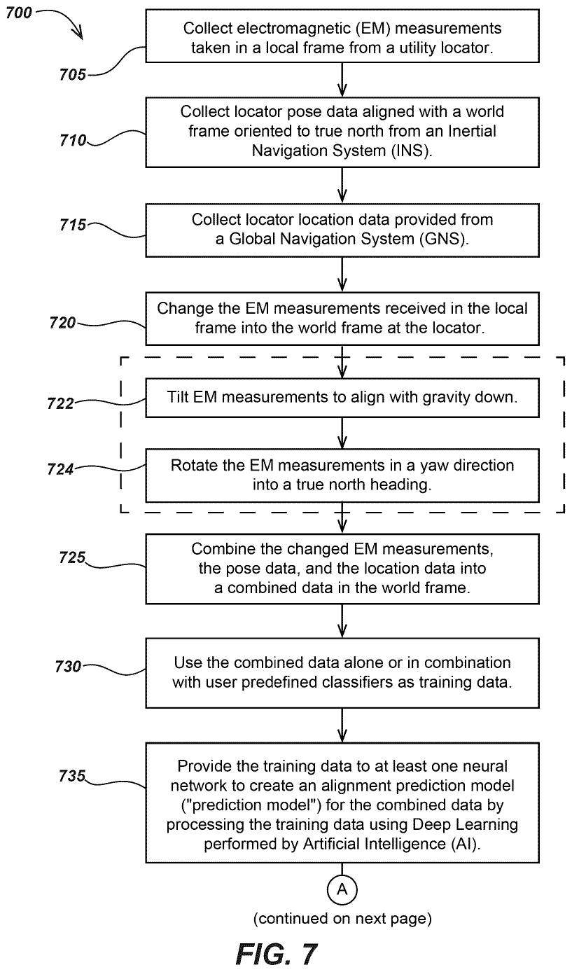

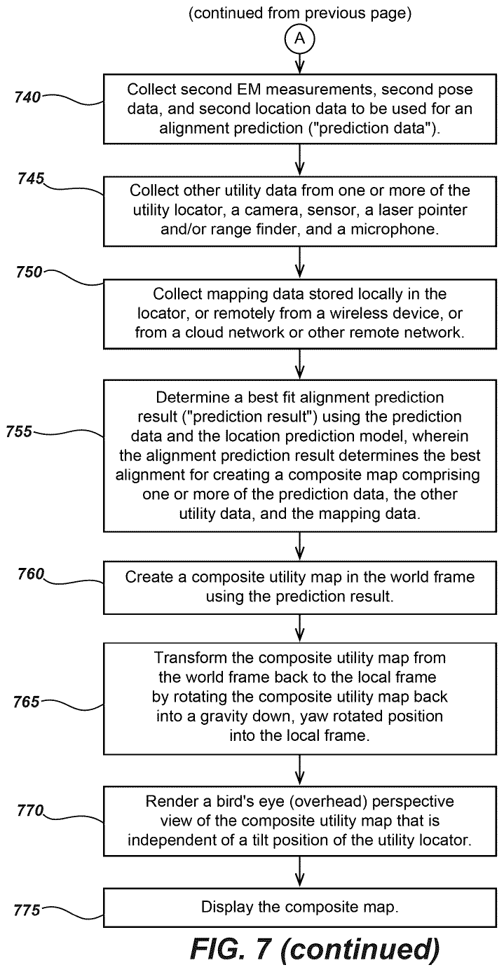

FIG. 7 illustrates details of an exemplary method 700 a method for transforming utility locator data from a local frame to a world frame, and back to a local frame in a utility locating system. In step 705, electromagnetic (EM) measurements taken in a local frame are collected from a utilty locator. In step 710, locator pose data aligned with a world frame oriented to true north is collected from an from an Inertial Navigation System (INS). Next, in step 715, locator location data provided from a Global Navigation System (GNS) is collected. In step 720, EM measurements received in the local frame are changed into the world frame at the locator with substeps 722, tilting the EM measurements to align with gravity down, and 724, rotating the EM measurements in a yaw direction into a true north heading. Next, in step 725, the changed EM measurements, the pose data, and the location data are combined the world frame into combined data.

In step 730, the combined data is used alone or in combination with user predefined classifiers as training data. Proceeding to step 735, the training data is provided to at least one neural network to create an alignment prediction model (“prediction model”) for the combined data by processing the training data using Deep Learning performed by Artificial Intelligence (AI). Next, in step 740, the second EM measurements, second pose data, and second location data are collected to be used for an alignment prediction (“prediction data”). In step 745, other utility data from from one or more of the utility locator, a camera, a sensor, a laser pointer and/or range finder, and a microphone is collected. Other utility data may include electromagnetic (EM) measurement data, imaging data, laser pointer data, and or range finding system data, utility survey and mapping data. Laser data may include ranging data (e.g. LIDAR), reflectance, and/or reflectivity data, tagged/annotated utility asset data, environmental data, and any other types of data related to utility locating and surveying.

In step 750, mapping data stored locally in the locator, or remotely from a wireless device, or from a cloud network or other remote network is collected. Next, in step 755, a best fit alignment prediction result (“prediction result”) is determined using prediction data and the location prediction model, wherein the alignment prediction result determines the best alignment for creating a composite map comprising one or more of the prediction data, the other utility data, and the mapping data. Proceeding to step 760, a composite utility map is created in the world frame using the prediction result. Next, in step 765, the composite utility map is transformed from the world frame back to the local frame by rotating the composite utility map back into a gravity down, yaw rotated position into the local frame. In step 770, rendering a bird's eye (overhead) perspective view of the composite map is performed. In step 775, the composite map is displayed. The composite map may be displayed at the utility locator/GLR, and/or remotely on one or more mobile devices such as a mobile phone, laptop, tablet, or on a vehicle display or navigation system.

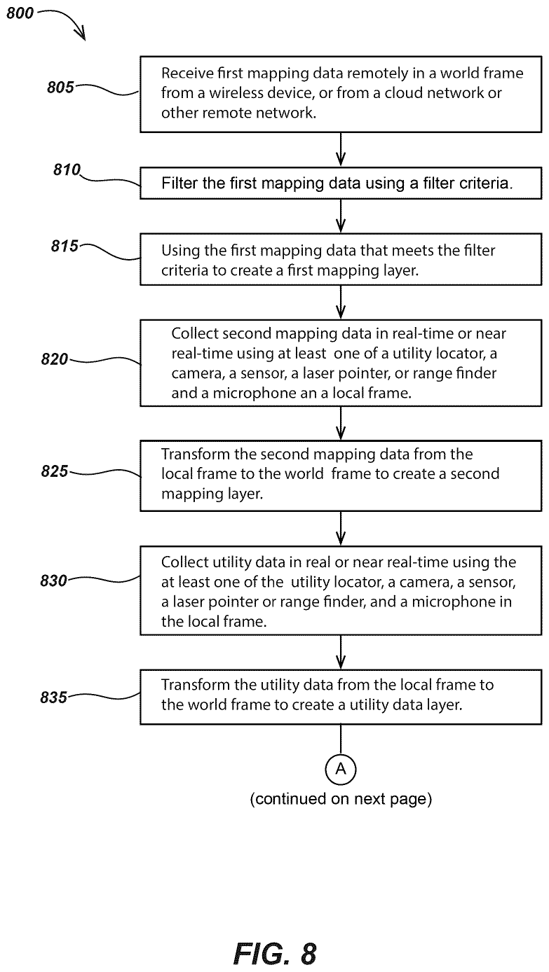

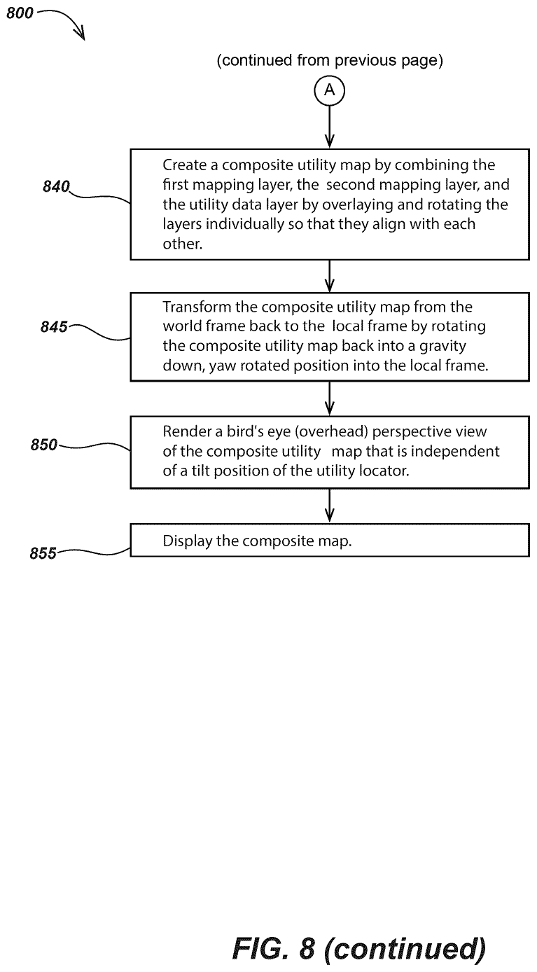

FIG. 8 illustrates details of an exemplary method 800 for creating a composite map of utility location data to be rendered in a local frame reference. The method starts at step 805 by receiving mapping data remotely in a world frame from a wireless device, or from a cloud network or other remote network. Mapping data may include geographic mapping data, surveying mapping data, e.g. utility survey data, location or geographical mapping data, utility or geographical feature data, e.g. land marks, coordinates, signage, trees or other natural features, road maps, or other geographic or utility line mapping data well known in the art. Next, at step 810, first mapping data is filtered using a filter criteria. For instance, the filter criteria may be a certain location, a specific time frame, a certain time of map (e.g. including or excluding certain features or terrain), or may include or exclude any other type of mapping feature obvious to one of ordinary skill in the art. At step 815, the first mapping data that meets the filter criteria is used to create a first mapping layer. Proceeding to step 820, second mapping data is collected in real-time or near real-time using at least one of a utility locator, a camera, a sensor, a laser pointer, or range finder and a microphone an a local frame. Second mapping data may include imaging data, laser range finding system data, tagged asset data, utility survey and mapping data, and utility asset data, and the like. It would be understood by one of ordinary skill in the art that many other types of second mapping data could be used. In step 825, second mapping data is transformed from from the local frame to the world frame to create a second mapping layer. Transforming second mapping data from the local frame to the world frame to create a second mapping layer may include tilting second mapping data to align with gravity down, and rotating and data in a yaw direction into a true north heading. There are many techniques, algorithms, software programs, etc. that are well known in the art that may be used to align, rotate, overlap, combine, or otherwise manipulate the data.

Proceeding to step 830, utility data is collected data in real or near real-time using at least one of the utility locator, a camera, a sensor, a laser pointer or range finder, and a microphone in the local frame. Collected data may include electromagnetic (EM) measurement data, imaging data, laser pointer data, and or range finding system data, utility survey and mapping data. Laser data may include ranging data (e.g. LIDAR), reflectance, and/or reflectivity data, tagged/annotated utility asset data, environmental data, and any other types of data related to utility locating and surveying. Proceeding to step 835, the utility data is transformed from the local frame to the world frame to create a utility data layer. Transforming utility data from the local frame to the world frame to create a utility data layer may include may include tilting second mapping data to align with gravity down, and rotating and data in a yaw direction into a true north heading. There are many techniques, algorithms, software programs, etc. that are well known in the art that may be used to align, rotate, overlap, combine, or otherwise manipulate the data.

In step 840, a composite utility map is created by combining the first mapping layer, the second mapping layer, and the utility data layer by overlaying and rotating the layers individually so that they align with each other. Aligning the layers may scaling, rotating, overlapping, or otherwise manipulating the data. There are also many other techniques, algorithms, software programs, etc. that are well known in the art that may be used to align, rotate, overlap, combine, or otherwise manipulate the data. In step 845, the composite utility map is transformed from the world frame back to the local frame by rotating the composite utility map back into a gravity down, yaw rotated position into the local frame.

Proceeding to step 850, rendering a bird's eye (overhead) perspective view of the composite map is performed. In step 855, the composite map is displayed. The composite map may be displayed at the utility locator/GLR, and/or remotely on one or more mobile devices such as a mobile phone, laptop, tablet, or on a vehicle display or navigation system.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. A portable buried utility mapping system for transforming utility locator data from a local frame to a world frame, and then back to a local frame, comprising:
a hand-held or vehicle mounted utility locator for making electromagnetic (EM) measurements by detecting electromagnetic signals emitted from one or more buried or hidden utilities, wherein the EM measurements are collected in a local frame;
an Inertial Navigation System (INS) module in communication with the utility locator for providing locator pose data aligned with a world frame oriented to true north;
a Global Navigation System (GNS) in communication with the utility locator for providing location data in the world frame to the utility locator;
an alignment module comprising one or more processors configured to change the EM measurements received in the local frame into a world frame by tilting the EM measurements to align with gravity down, and rotating the EM measurements in a yaw direction into a true north heading;
a mapping module comprising one or more processors configured to combine the changed EM measurements, the pose data, and the location data into a composite utility map in the world frame; and
a transformation module comprising one or more processors configured to transform the composite utility map from the world frame back to the local frame by rotating the composite utility map back into a gravity down, yaw rotated position into the local frame, and render a bird's eye (overhead) perspective view of the composite utility map that is independent of a tilt position of the utility locator.

2. The mapping system of claim 1, wherein combining the changed EM measurements, the pose data, and the location data comprises one or more of manipulating, enhancing, aligning, filtering, and rotating one or more of the changed EM measurements, the pose data, and the location data to align into the world frame.

3. The mapping system of claim 2, further comprising a display for displaying the transformed utility map EM measurements as graphical representations of utility lines mapped in the world frame with a global coordinate system relative to true north.

4. The mapping system of claim 1, wherein transforming EM measurements is performed in real-time or near real time.

5. The mapping system of claim 1, further comprising a wireless module for communicating mapping and/or utility data from a mobile device, a cloud network, or remote server to/from the utility locator.

6. The portable mapping system of claim 5, wherein at least one of the one or more processors is configured to align the mapping and/or utility data with the transformed EM measurements in the world frame, and combine the mapping and/or utility data with the EM measurements to create a composite utility map in the world frame.

7. The mapping system of claim 6, wherein the composite map also includes other utility data collected from one or more of the utility locator, a camera, a sensor, a laser pointer and/or range finder, and a microphone.

8. A method for transforming utility locator data from a local frame to a world frame, and back to a local frame in a utility locating system, comprising:
making electromagnetic (EM) measurements in the local frame in real-time or near real-time via a hand-held or vehicle mounted utility locator by detecting electromagnetic signals emitted from one or more buried or hidden utilities;
providing locator pose data aligned with a world frame oriented to true north from an Inertial Navigation System (INS) to the utility locator;
providing location data from a Global Navigation System (GNS) to the utility locator;
changing the EM measurements received in the local frame into the world frame, comprising:
tilting the EM measurements to align with gravity down, and rotating the EM measurements in a yaw direction into a true north heading;
combining the changed EM measurements, the pose data, and the location data into a composite utility map in the world frame;
transforming the composite utility map from the world frame back to the local frame by rotating the composite utility map back into a gravity down, yaw rotated position into the local frame; and
rendering a bird's eye (overhead) perspective view of the composite utility map that is independent of a tilt position of the utility locator.

9. The method of claim 8, wherein combining the changed EM measurements, the pose data, and the location data comprises one or more of manipulating, enhancing, aligning, filtering, and rotating one or more of the changed EM measurements, the pose data, and the location data to align into the world frame.

10. The method of claim 9, further comprising displaying the transformed utility map EM measurements as graphical representations of utility lines mapped in the world frame with a global coordinate system relative to true north.

11. The method of claim 9, wherein transforming EM measurements is performed in real-time or near real time.

12. The method of claim 9, further comprising communicating mapping and/or utility data from a mobile device, a cloud network, or remote server to/from the utility locator.

13. The method of claim 9, further comprising aligning the mapping and/or utility data with the transformed EM measurements in the world frame, and combining the mapping and/or utility data with the EM measurements to create a composite utility map in the world frame.

14. The method of claim 13, wherein the composite map also includes other utility data collected from one or more of the utility locator, a camera, a sensor, a laser pointer and/or range finder, and a microphone.

15. A method for transforming utility locator data from a local frame to a world frame, and back to a local frame in a utility locating system, the method using Artificial Intelligence (AI), comprising:
collecting electromagnetic (EM) measurements taken in a local frame from a utility locator;
collecting locator pose data aligned with a world frame oriented to true north from an Inertial Navigation System (INS);
collecting locator location data provided from a Global Navigation System (GNS);
changing the EM measurements received in the local frame into the world frame at the locator, comprising:
tilting the EM measurements to align with gravity down, and rotating the EM measurements in a yaw direction into a true north heading;
combining the changed EM measurements, the pose data, and the location data into a combined data in the world frame;
using the combined data alone or in combination with user predefined classifiers as training data;
providing the training data to at least one neural network to create an alignment prediction model (“prediction model”) for the combined data by processing the training data using Deep Learning performed by Artificial Intelligence (AI);
collecting second EM measurements, second pose data, and second location data to be used for an alignment prediction (“prediction data”);
collecting other utility data from one or more of the utility locator, a camera, a sensor, a laser pointer and/or range finder, and a microphone;
collecting mapping data stored locally in the locator, or remotely from a wireless device, or from a cloud network or other remote network;
determining a best fit alignment prediction result (“prediction result”) using the prediction data and the location prediction model, wherein the alignment prediction result determines the best alignment for creating a composite map comprising one or more of the prediction data, the other utility data, and the mapping data;
creating a composite utility map in the world frame using the prediction result;
transforming the composite utility map from the world frame back to the local frame by rotating the composite utility map back into a gravity down, yaw rotated position into the local frame;
rendering a bird's eye (overhead) perspective view of the composite utility map that is independent of a tilt position of the utility locator; and
displaying the composite map.

16. A method for creating a composite map of utility location data to be rendered in a local frame reference, comprising:
receiving first mapping data remotely in a world frame from a wireless device, or from a cloud network or other remote network;
filtering the first mapping data using a filter criteria;
using the first mapping data that meets the filter criteria to create a first mapping layer;
collecting second mapping data in real-time or near real-time using at least one of a utility locator, a camera, a sensor, a laser pointer, or range finder and a microphone an a local frame;
transforming the second mapping data from the local frame to the world frame to create a second mapping layer;
collecting utility data in real or near real-time using the at least one of the utility locator, a camera, a sensor, a laser pointer or range finder, and a microphone in the local frame;
transforming the utility data from the local frame to the world frame to create a utility data layer;
creating a composite utility map by combining the first mapping layer, the second mapping layer, and the utility data layer by overlaying and rotating the layers individually so that they align with each other;
transforming the composite utility map from the world frame back to the local frame by rotating the composite utility map back into a gravity down, yaw rotated position into the local frame;
rendering a bird's eye (overhead) perspective view of the composite utility map that is independent of a tilt position of the utility locator; and
displaying the composite map.

17. The method of claim 16, wherein the first mapping data that does not meet the filter criteria is discarded.

18. The method of claim 16, wherein the first mapping data that does not meet the filter criteria is stored, logged, or otherwise saved.

19. A portable buried utility mapping system for transforming utility locator data from a world frame to a local frame, comprising:
a hand-held or vehicle mounted utility locator for making electromagnetic (EM) measurements by detecting electromagnetic signals emitted from one or more buried or hidden utilities, wherein the EM measurements are collected in a local frame;
a world frame object module for providing mapping and/or utility objects in the world frame to the locator;
an alignment module comprising one or more processors configured to transform the objects received from the world frame into a gravity down local frame reorientation;
a mapping module comprising one or more processors configured to combine the EM measurements with the transformed world frame objects in the local frame, and render a bird's eye (overhead) perspective view of the composite utility map that is independent of a tilt position of the utility locator; and
a display for displaying the composite map.
